(19) United States
(12) Patent Application Publication
(10) Pub. No.: US 2008/0099514 A1
(43) Pub. Date: May 1, 2008

(54) Pourer

(76) Inventors: Daniel Carter, Kambah (AU); Glenn Lawrence, Kambah (AU)

Correspondence Address: WELSH & KATZ, LTD, 120 S RIVERSIDE PLAZA, 22ND FLOOR, CHICAGO, IL, 60606, US

(21) Appl. No.: 11/666,454

(22) PCT Filed: Nov. 22, 2005
(86) PCT No.: PCT/AU05/01771

§ 371 Date: Jun. 6, 2007

(30) Foreign Application Priority Data
Nov. 22, 2004 (AU) 2004906686

(51) Int. Cl. A47G 19/12; B67D 3/00; F16K 7/04; B65D 5/72

(52) U.S. Cl. 222/472; 251/7; 222/517; 222/484; 222/567

(57) ABSTRACT

A pourer (10) couplable to an opening (12) of a container (14). The pourer (10) includes a spout (20), which has an outlet passage (22) for discharging liquid from the container (14) and a breather passage (24) for intake of air into the container (14). At least a portion of the spout (20) being deformable, and the outlet passage (22) and breather passage (24) co-extending through the deformable portion. A closure device (34) is used to selectively clamp the deformable portion of the spout (20), thereby closing the spout (20) by constricting both passages (22, 24).

The present invention relates to a pourer couplable to an opening of a container and a container incorporating a pourer.

### BACKGROUND

Many liquids of different viscosity are sold in containers that come in different shapes and sizes. The openings at the top of these containers are not generally shaped to achieve precise pouring. As such, pouring from these containers often results in spillage. This is especially the case where the containers are full. Another inconvenience of these containers is the limited ability to control the quantity of flow of liquid from the container.

The quality and control over the flow of liquid can be improved by fitting a pourer to the opening of the container. Some pourers include two channels, which facilitate liquid flow out of the container by simultaneously allowing a flow of air into the container. Although functional these pourers do not generally provide for closure of the container with an effective airtight seal. Consequently, it is generally necessary to remove the pourer and refit a lid to the container to achieve airtight closure.

A drink bottle closure is described in International Patent Application WO 1998/007633. The closure includes a cap fitted with a flexible dispensing tube and a separate ventilating pathway is integrally moulded into the rigid cap. A closing element bends the dispensing tube to effect sealing of the tube and seal the ventilating pathway by covering the outlets with part of the dispensing tube. Whilst this arrangement provides a degree of sealing, the effectiveness of the seal of the ventilating pathway, which relies of clamping contact of the dispensing tube is not likely to be high. In the described arrangement this is not critical because the ventilating pathway contains a liquid impermeable layer. The closure of WO 1998/007633 also fails to provide for progressive opening of the spout to control liquid flow. Again in the drink bottle this is not important because it is normally used in a fully open condition and closed fully when not in use. Another shortcoming of the arrangement is the length of spout downstream of sealing which leaves an exposed unsealed amount of spout.

U.S. Pat. No. 5,501,375 discloses a dispenser valve for a liquid pressurised in a container. An actuator folds a length of tubing to control passage of liquid through the tube for dispensing. Because the contents of the container are pressurised admission of air to the container is not required during dispensing.

U.S. Pat. Nos. 4,666,064 and 3,081,003 both show dispensers for “bag in the box” packages in which a flexible spout is clamped to control dispensing of the contents. In these dispensers flow quality is not a major concern and a separate passage for simultaneous admission of air to the container is not provided. Additionally the flow of liquid from the dispenser is generally determined by the amount of liquid remaining in the container.

A tap known as the ‘aeroflow tap’ from Worldwide Dispensers/DS Smith Plastics Ltd., allows for self venting. These taps are used with the container resting on a flat surface whilst dispensing into a receptacle positioned under the tap. These types of tap do not offer the flexibility of using the container in the manner of a jug with one hand. This is because the tap or press button action does not allow a user to lift the container and both operate the mechanism and pour with one hand. Furthermore, tap dispensers typically suffer from the disadvantages of having a slow pour when compared to the speed of pouring without the dispenser, and of requiring multiple mouldings for venting and flow.

Preferred embodiments of the present invention seek to overcome, or alleviate, one or more of the above-described disadvantages, or at least provide a useful alternative.

### SUMMARY

In accordance with the present invention, there is provided a pourer couplable to an opening of a container, including:
(a) a spout having an outlet passage for discharging liquid from the container and a breather passage for intake of air into the container, at least a portion of said spout being deformable, and said outlet passage and said breather passage co-extending through the deformable portion; and
(b) a closure device for selectively clamping the deformable portion of the spout to constrict said outlet passage and breather passage and effect closure of the spout.

Preferably, at least a substantial portion of the spout is made of a deformable material. The deformable material is preferably resilient. In one form of the invention the pourer can incorporate a moulded body into which an insert incorporating the spout is fitted. Preferably the insert is readily removable so as to provide for cleaning of the spout. In one form of the invention the insert is formed as a single moulding.

In another form of the invention the pourer includes a moulded body portion through which the outlet passage and breather passage extend and a deformable portion that is joined to the moulded body for example by gluing or welding.

Preferably the outlet passage and breather co-extend over substantially the length of the spout. In preferred forms of the invention the outlet passage and breather passage are substantially parallel over a significant length of the spout.

Preferably the cross sectional area of the breather passage increases substantially in the direction opposite to the direction of intake of air over a relatively short distance in comparison to the overall length of the breather channel. This significant increase in cross section can be by way of a step, a series of steps, or a taper over a relatively short distance. The provision of this change in cross section area assists in an efficient commencement of the admission of air to the container via the breather passage which results in improved flow characteristics from the outlet passage. The spacing of this increase in cross section from the point at which the spout is clamped may also improve flow characteristics

The closure device preferably includes a closure member pivotally movable to clamp the deformable portion. Preferably, the constricting and closure is effected by clamping the deformable portion between the closure member and a backing plate. In a preferred form of the invention the closure member is a pivotal lever manually operable by pressure at one end to selectively apply and release the clamping pressure. In this form of the invention the lever is resiliently biased toward a clamping position in which the spout is closed.

In the preferred form of the invention the clamping and constriction of the deformable portion is progressive so that the flow of liquid from the outlet passage can be controlled.

In the preferred form of the invention the spout is clamped closely adjacent to the free end so as to minimise the amount of unclosed spout exposed to the air.

Preferably, the spout is generally tubular and divided into two passageways by a central wall. Preferably, clamping of the spout results in deformation so that the contacting surfaces of the walls defining the passageways are of the same effective length. In one form of the invention the spout is clamped between a curved backing plate and the end of a lever.

The pourer of this invention can be coupled to a container in any suitable manner. In one form of the invention a universal coupling ring is provided that is compatible with the types of threads used on most containers. The ring can engage a thread or other formation of the container in any suitable way. For example the ring may snap engage or have the same or a partially compatible thread. Preferably the coupling includes a resilient tubular formation which fits into the container opening. The tubular formation is preferably sufficiently compliant to allow for minor imperfections in container openings.

In another aspect the invention provides a pourer including a coupling having circumferentially arranged jaws which clamp against an upper marginal edge portion of the container, a retaining ring surrounding the jaws to effect said clamping by movement with respect to the jaws to urge the jaws inwardly. Preferably the jaws are formed by segments of a cylindrical skirt. Preferably clamping is effected by engagement of the jaws with a thread or other formation on the container normally used for securing a closure.

In another aspect the present invention provides a container incorporating a pourer as described above. The pourer can be fully or substantially integral with the container or removable or include removable components.

### DESCRIPTION OF THE DRAWINGS

The invention will now be described, by way of example only, with reference to the accompanying drawings in which:

FIG. 1 is a schematic cross sectional view of a pourer according to a first embodiment of the invention attached to a container;

FIG. 2 is a schematic side view of the pourer of FIG. 1 in a open condition;

FIG. 3 is a schematic side view similar to FIG. 2 showing the pourer in a closed condition.

FIG. 4 is a schematic perspective view of a pourer according to a second embodiment of the invention;

FIG. 5 is a schematic elevation of the pourer shown in FIG. 4;

FIG. 6 is a schematic sectional view of the pourer shown in FIGS. 4 and 5;

FIG. 7 is a schematic perspective view of an insert forming part of the pourer shown in FIG. 4;

FIG. 8 is a schematic elevation of the insert shown in FIG. 7;

FIG. 9 is a schematic sectional view of the insert shown in FIG. 7;

FIG. 10 is a schematic perspective view of a pourer body forming part of the pourer shown in FIG. 4;

FIG. 11 is a schematic elevation of the pourer body shown in FIG. 10;

FIG. 12 is a schematic perspective view of a retaining ring forming part of the pourer shown in FIG. 4;

FIG. 13 is a schematic sectional view of the retaining ring shown in FIG. 12;

FIG. 14 is a schematic sectional view similar to FIG. 6 showing the pourer in a closed condition and partially fitted to a container;

FIG. 15 is a schematic sectional view similar to FIG. 14 showing the pourer in an open condition and fully fitted to a container;

FIG. 16 is a schematic view looking at the spout end of the pourer of FIG. 4 in an open condition;

FIG. 17 is a schematic view similar to FIG. 16 showing the pourer in a closed condition; and

FIG. 18 is a schematic sectional view of a further embodiment of a pourer according to the present invention.

### DETAILED DESCRIPTION OF PREFERRED EMBODIMENTS

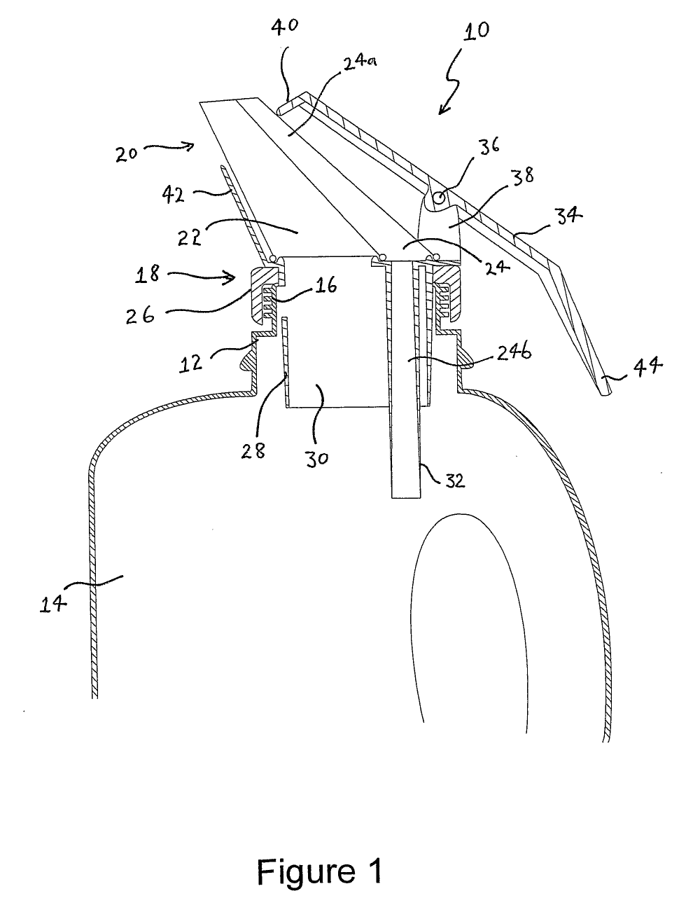

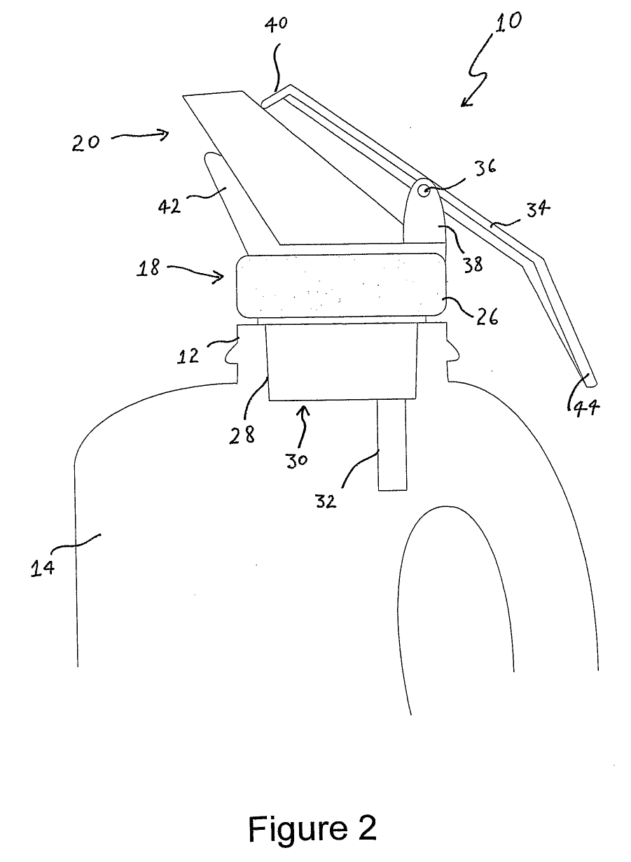

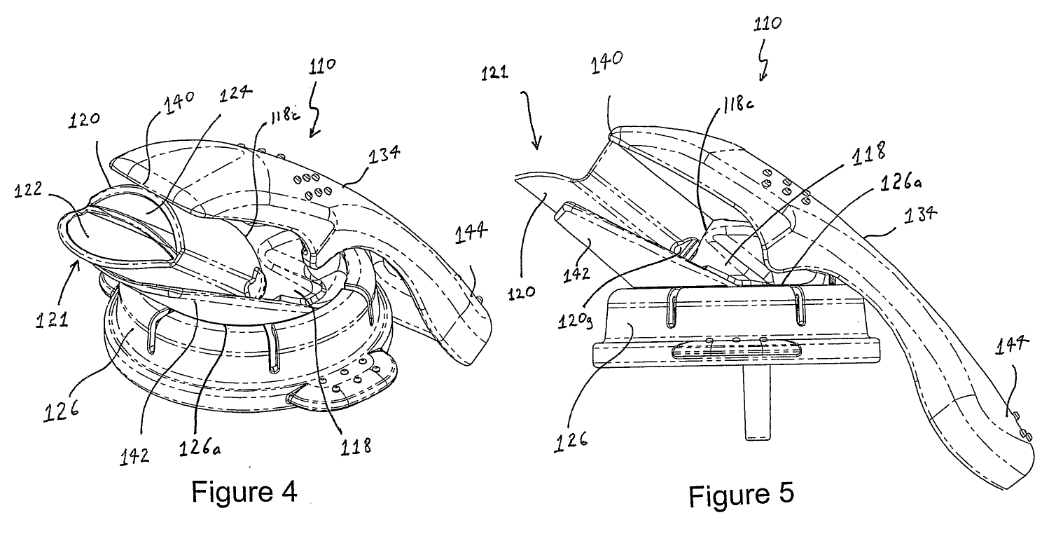

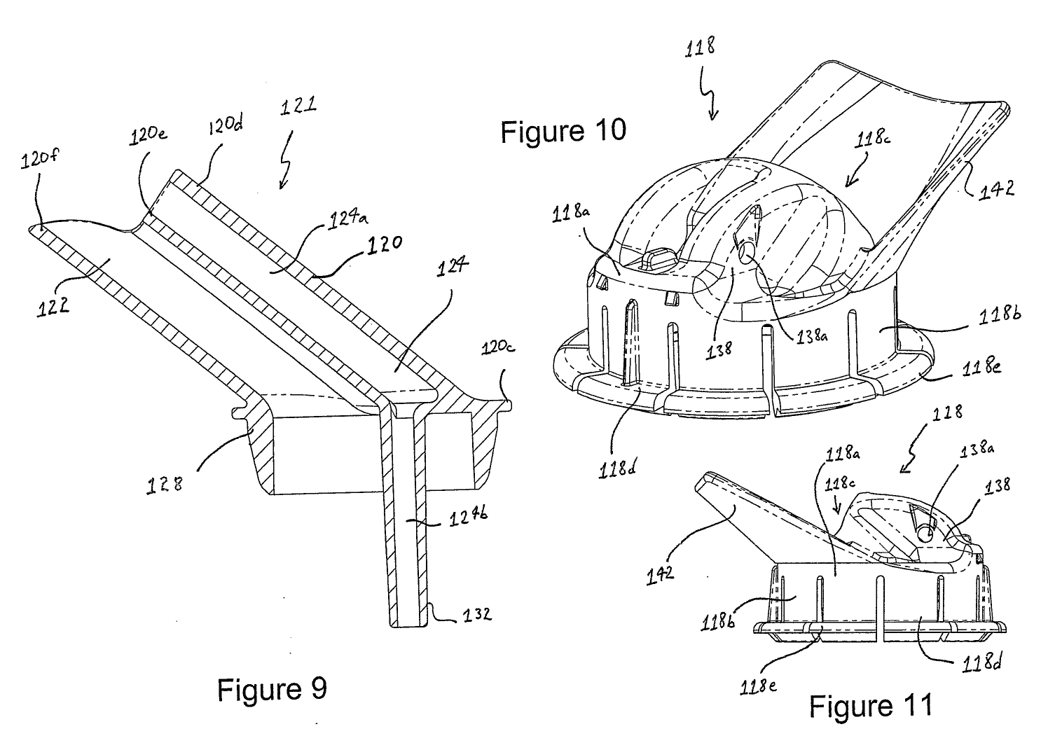

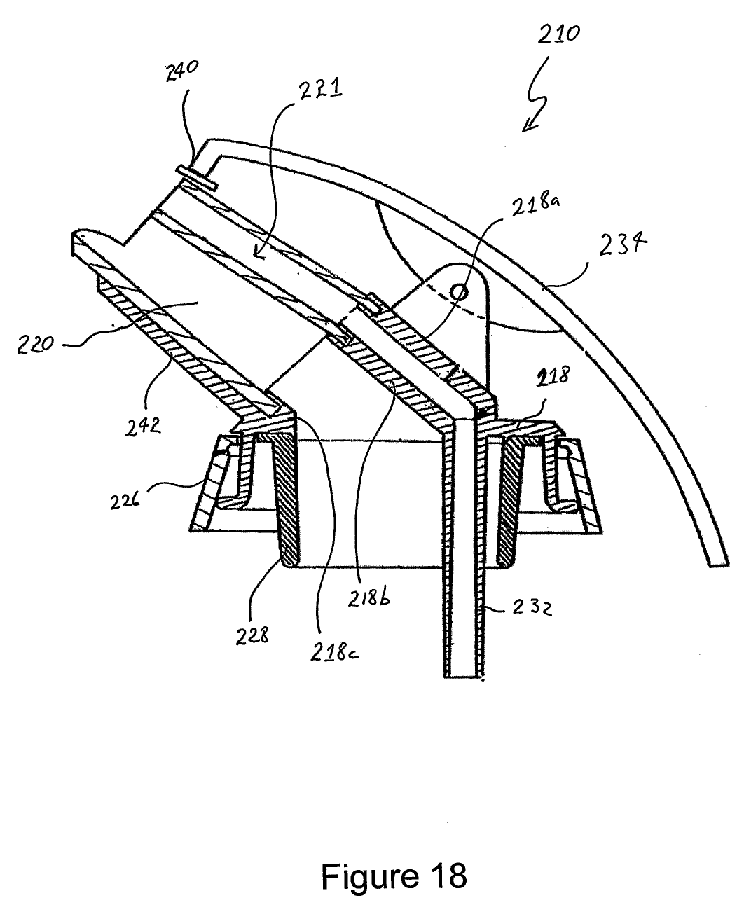

FIGS. 1 to 3 show a first embodiment of the invention which illustrates the general principle of operation of the pourer. The embodiments shown in FIGS. 4 to 17 show a preferred embodiment of the invention. FIG. 18 shows an alternative construction for the pourer.

Referring firstly to FIGS. 1 to 3 the pourer 10 is shown fitted to the neck 12 of a container 14. Container 14 is a standard type of plastic container with a thread 16 formed around the neck 12. The pourer 10 is formed by a moulded body 18 to which a resiliently deformable spout 20 is attached. The spout 20 includes two co-extending passageways 22 and 24. Passageway 22 is an outlet passage for the discharge of fluid from container 14. Co-extending passage 24 is a breather passage that allows the admission of air to the container 14 during pouring.

The pourer 10 is secured to the neck 12 of the container 14 by means of a coupling ring 26 which resiliently engages with threaded portion 16 on the neck 12. A tubular formation 28 depends from the body 18 of the pourer and is formed of a resilient material so as to tightly engage the upper interior of the neck 12 of the container. This provides an airtight seal between the pourer 10 and container 14.

Passageway 22 is in communication with the interior of container 14 by way of the interior 30 of tubular formation 28. Breather passage 24 extends through the moulded body portion 18 of the pourer via a moulded tube 32 which protrudes into container 14. Breather passageway 24 steps to a reduced cross sectional area where deformable spout 20 connects with body portion 16. That is, an upper portion 24a has a larger cross-sectional area than a lower portion 24b. This rapid decrease in cross sectional area provides for improved initiation of admission of air to the container 14 during pouring as will be described below.

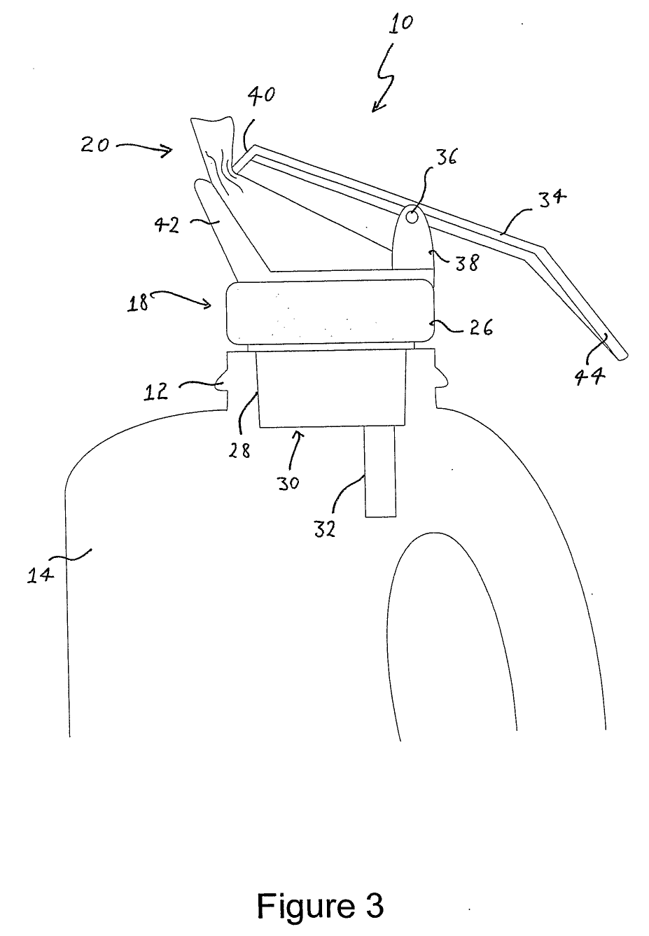

A closure device in the form of a lever 34 is pivotally mounted at 36 with the body 18 by way of a bracket 38 moulded on the body. The lever 34 is biased by a spring (not shown) in a anti-clockwise direction (as shown in the drawings) so as to move towards a closed position as shown in FIG. 3. In the closed position an inturned end 40 of lever 34 clamps the spout 20 against a backing plate 42 forming part of moulded body 18. This constricts the passageways 22 and 24 to close the spout 20. Pressure on an operating end 44 of the lever 34, which is usually applied by way of a finger, will rotate the lever 34 about the pivot 36. It will be apparent that by selectively applying pressure to the end 44 of lever 34 the amount of opening of the passageways 22, 24 can be controlled.

In use the pourer is used by partially inverting the container 14 with passageway 22 lowermost to allow the contents to flow into passageways 22 and 24. Operation of the lever 34 by pressure on end 44 allows the passageways 22, 24 to be selectively partially or fully opened. Initially passageway 24 may be full of liquid from the container but upper portion 24a of passageway will empty from the end of spout quickly. At the same time the ambient pressure within the container 14 will reduce with the discharge of the contents through passageway 22. The remaining liquid in portion 24b will consequently be drawn into the container by the action of air pressure. The substantial change in cross sectional area of passageway 24 facilitates this emptying of passageway 24 to allow the admission of air. This configuration has been found to much more efficiently establish the admission of air to the container than in the case of a passageway of substantially constant cross section. In particular the sudden change in cross section area results in an earlier establishment of air flow into the container and avoids a “glugging” flow from outlet passage 22.

When the desired amount of liquid has been dispensed the lever 34 is released and it assumes the closed position shown in FIG. 3 terminating the flow of liquid from the container. It will be apparent that this provides a positive and immediate cut-off of liquid flow so as to prevent other than a very minor amount of dripping from the end of the spout 20. The clamping of the end of spout 20 by the in turned 40 of lever 34 provides an airtight seal suitable for the storage of most container contents.

FIGS. 4 to 14 show a preferred form of the invention. Corresponding reference numerals (preceded by the reference numeral “1”) have been used to identify corresponding portions of the invention as described in relation to the first embodiment. Letter suffixes are used to identify additional detail of corresponding features.

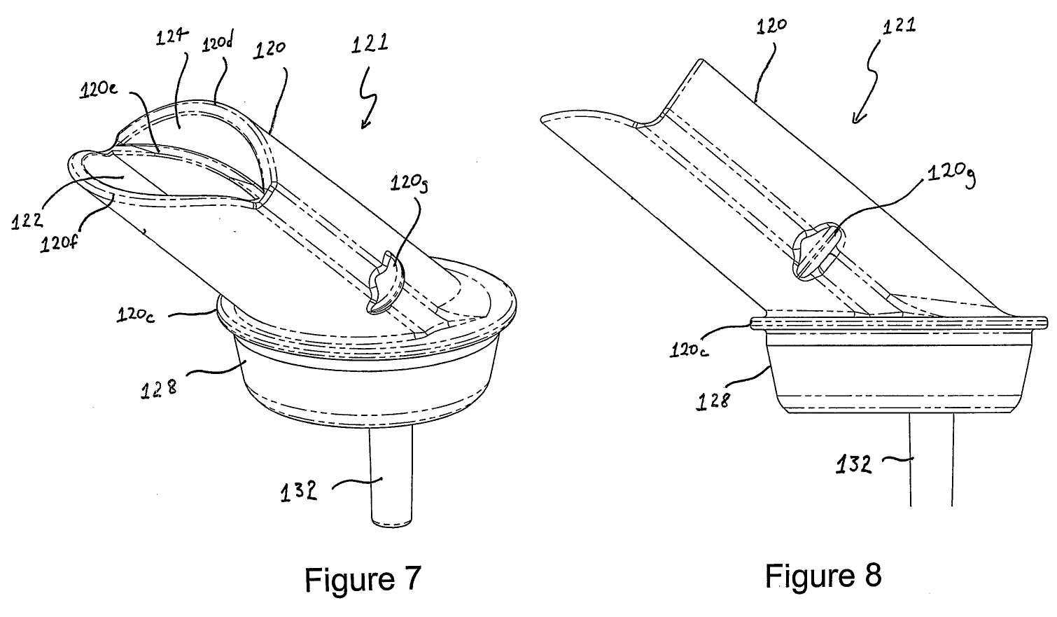

In this embodiment of the invention the spout 120 is part of an insert 121 that fits within moulded body 118 of the pourer 110. The insert 121 is made from a silicone material selected so as to be resiliently deformable but sufficiently stiff to retain the shape of the insert in use. As best seen in FIGS. 7 to 9 the insert 121 has an elongate spout 120 and tubular formation 128. A circumferential flange 120c extends around the upper end of tubular formation 128. A tube 132 extends from the spout 120 through tubular formation 128.

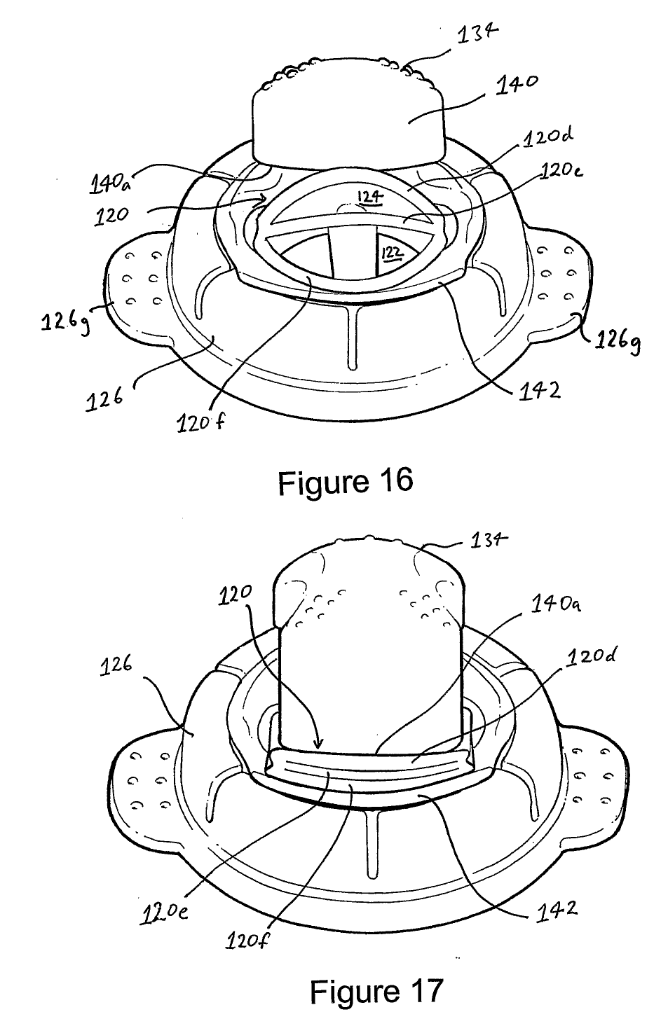

The elongate spout 120 includes co-extending outlet passageway 122 and breather passageway 124. As seen in FIG. 7 (and FIGS. 16 and 17) spout 120 includes an upper outer wall portion 120d a dividing wall 120e and a lower outer dividing wall portion 120f defining passages 122 and 124. Passageways 122 and 124 are generally semi-circular in cross section and the length of walls 120d, 120e and 120f are determined so that in the closed configuration (FIG. 17) the effective lengths of the contacting surfaces of each wall is substantially the same to provide a sealing closure. This can be achieved by some stretching of one or more of walls 120d, 120e and 120f in the closed configuration if necessary. Closure of the spout 120 is described in further detail below. Passageway 122 communicates with the interior of tubular formation 128 to provide communication with the container into which the pourer 110 is fitted. Passageway 124 is formed by a upper portion 124a in spout 120 and lower portion 124b in tube 132 with a change in cross-sectional area at the junction. Locating lugs 120g are provided approximately midway along the spout 120.

FIGS. 10 and 11 show a body portion 118 of the pourer 110. The body portion takes the form of a central hub 118a surrounded by a depending segmented skirt 118b. A curved backing plate 142 extends upwardly and outwardly from the hub 118a. Hub 118a also includes bracket portions 138 having apertures 138a to provide for pivotal mounting of a lever 134 (described below). The interior of hub 118a is hollow and an aperture 118c is provided adjacent the backing plate 142 for the insertion of the insert 121 described above. Skirt 118b is segmented to form a number of jaws 118d. Each jaw 118d has an outwardly extending flange 118e formed at the lower marginal edge. The segmented nature of skirt 118b allows the jaws 118d to deflect inwardly as will be described below.

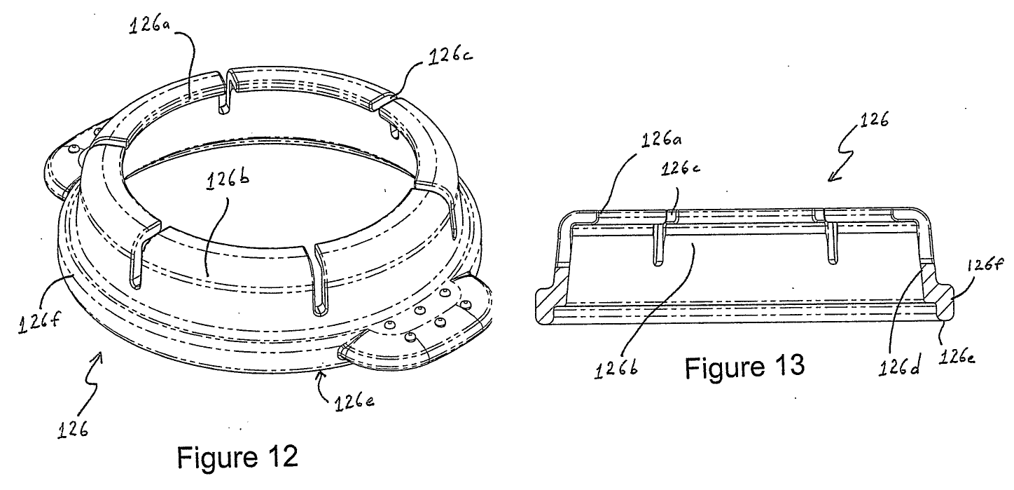

FIGS. 12 and 13 show a retaining ring 126 that fits over the body 118 described above. The retaining ring 126 takes the form of a generally cylindrical cap with a top opening 126a. The sides of the cap are divided into a number of wall segments 126b by slots 126c. This allows for some expansion of opening 126a so as to facilitate sliding over the body 118. The inner surface 126d of wall segments 126b taper outwardly toward the lower marginal edge 126e. A circumferential extending flange 126f extends around lower edge 126e. Diametrically opposed tabs 126g extend outwardly from the retaining ring 126 to assist in operation.

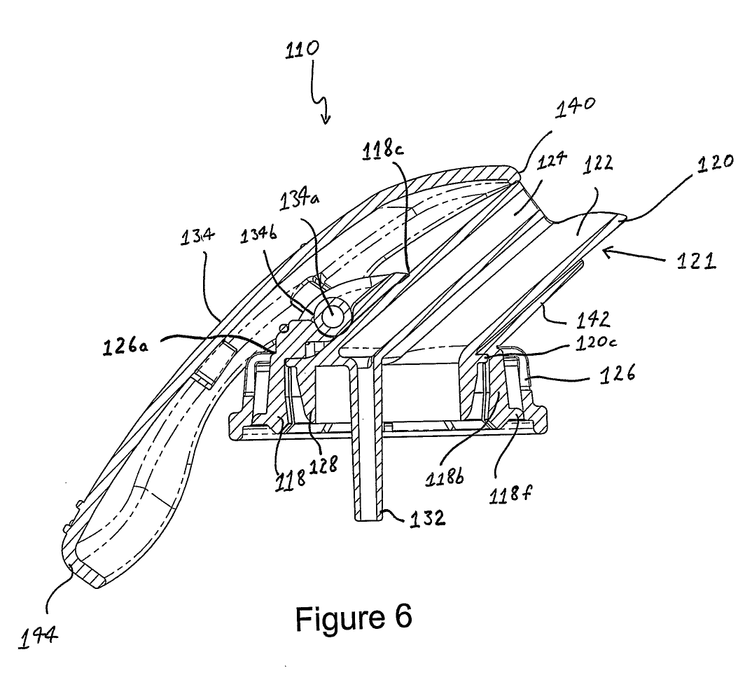

FIGS. 4 to 6 show the fully assembled pourer 110. The insert 121 is fitted through the opening 118c in the body 118 so as to overlie the backing plate 142. The insert is retained in position by abutment of the flange 120c against the under surface of the body 118. This can best be seen in FIG. 6. Locating lugs 120g abut the marginal edge of opening 126a. In this way the insert 121 is captively retained in the body 118. It will be apparent however that because the insert 121 is formed from a resilient material it can be elastically deformed and removed for cleaning and the like.

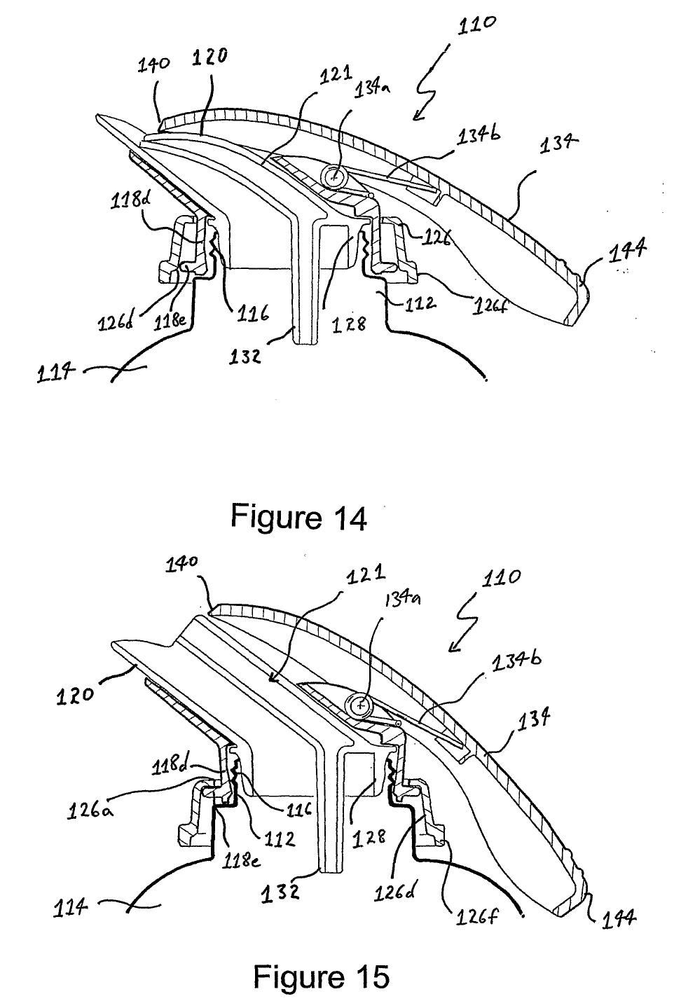

Retaining ring 126 fits over the body 118. The operation of retaining ring 126 in engaging the pourer with a container is best seen in FIGS. 14 and 15 and will be described below. The outer flange 118f of skirt 118b abuts the inner side of the retaining ring. This is also best shown in FIG. 6.

A lever 134 is pivotally mounted with body 118 by means of a pin 134a extending through the aperture 138a. A spring 138b is provided around pin 134a to bias the lever 134 in a clockwise direction as shown in FIG. 6 (anti clockwise as shown in FIG. 5). That is, the lever 134 is biased towards the closed position.

Closure of the spout is effected in the same way as described above in relation to the first embodiment by the end 140 of lever 134 clamping the spout 120 against backing plate 142 to constrict the passageways 122 and 124. The closing operation can be best seen in FIGS. 16 and 17. In FIG. 16 spout 120 is fully open and the passageways 122 and 124 have a generally semi-circular cross section. End 140 of lever 134 has a curved edge 140a. FIG. 17 shows the spout 120 fully closed. The spout is clamped close to its end between curved edge 140a and backing plate 142. As described above the length of walls 120d, 120e and 120f is determined so that having regard to the curvature of backing plate 142 and any stretching during clamping the effective lengths of the contacting surface of each wall is substantially the same. This allows an airtight seal to be achieved in the fully closed position. As in the case of the first embodiment it will be apparent that the passageways 122, 124 can be progressively opened between the closed position and a fully opened position by selective pressure on the end 144 of lever 134.

Connection of the pourer 110 with a container is shown in FIGS. 14 and 15. Tubular formation 128 is tapered so as to fit into the diameter of the neck 112 of the container 114. The resilient nature of the silicone from which insert 121 is formed means that it is sufficiently compliant for the tubular formation 128 to tightly fit into the neck 112 to locate the pourer 110 and provide an airtight seal.

In FIG. 14 the pourer 110 is partly fitted to container 114. Tubular formation 128 is fully engaged with neck 112 and jaws 118d overlie thread 116. Retaining ring 126 is in an unlocked position in which the lower ends of tapered inner surfaces 126d bear against jaw flanges 118e of jaws 118d. FIG. 15 shows the retaining ring moved to a locking position. Tabs 126g facilitate the application of force to move the retaining ring for example by thumb pressure. As the retaining ring is moved downwardly from the unlocked position shown in FIG. 14 tapered surfaces 126d force jaws 118d inwardly into clamping engagement with thread 116. In the locked position top 126a of the retaining ring 126 rests against jaw flanges 118e. Resilience of retaining ring 126 is provided by slots 126c which allow the top 126a to expand slightly as it moves to the locked position whilst the absence of slots and flange 126f largely prevent expansion of the lower edge 126e. Consequently the retaining ring 126 “snaps” into the locked position. Retaining ring 126 can be snapped back to the unlocked position for removal of the pourer from the container. It will be apparent that clamping by jaws 118d does not rely on threaded engagement. Consequently, the pourer can be used with containers having various types of thread irrespective of whether they are multi start threads, coarse threads, or relatively fine threads.

FIG. 18 shows a further embodiment of the invention generally similar to the first embodiment of FIGS. 1 to 3. Like reference numerals (proceeded by a “2”) are used to identify corresponding features. In the FIG. 18 embodiment spout 220 of pourer 210 is partly formed by rigid moulded extensions 218a, 218b and 218c of body 218. The end of spout 220 is formed by a resilient deformable end portion 221. Operation of the pourer 220 is the same as described for the other embodiments.

The foregoing describes only some embodiments of the invention and modifications can be made without departing from the scope of the invention.

Throughout this specification and the claims which follow, unless the context requires otherwise, the word ‘comprise,’ and variations such as ‘comprises’ and ‘comprising,’ will be understood to imply the inclusion of a stated integer or step, or group of stated integers or steps.

The reference to any prior art in this specification is not, and should not be taken as, an acknowledgment or any form of suggestion that that prior art form part of the common general knowledge in Australia.

1. A pourer couplable to an opening of a container, including:
a spout having an outlet passage for discharging liquid from the container and a breather passage for intake of air into the container, at least a portion of said spout being deformable, and said outlet passage and said breather passage co-extending through the deformable portion; and
a closure device for selectively clamping the deformable portion of the spout to constrict said outlet passage and breather passage and effect closure of the spout.

2. A pourer as claimed in claim 1 wherein at least a substantial portion of the spout is made of a deformable material.

3. A pourer as claimed in claim 2, wherein the deformable material is resilient.

4. A pourer as claimed in claim 1, further including a moulded body into which an insert incorporating the spout can be fitted.

5. A pourer as claimed in claim 4, wherein the insert is readily movable.

6. A pourer as claimed in claim 4, wherein the insert is formed by a single moulding.

7. A pourer as claimed in claim 1, further including a moulded body portion through which the outer passage and breather passage extend, and
a deformable portion that is joined to the moulded body portion.

8. A pourer as claimed in claim 7, wherein the deformable portion is joined to the moulded body by gluing or welding.

9. A pourer as claimed in claim 1, wherein the outlet passage and the breather passage co-extend over substantially the length of the spout.

10. A pourer as claimed in claim 1, wherein the outlet passage and breather passage are substantially parallel over a significant length of the spout.

11. A pourer as claimed in claim 1, wherein the cross sectional area of the breather passage increases substantially in the direction opposite to the direction of intake of air over a relatively short distance in comparison to the overall length of the breather channel.

12. A pourer as claimed in claim 11 wherein the substantial increase in cross sectional area of the breather passage is provided by one or more steps.

13. A pourer as claimed in claim 11 wherein the substantial increase in cross sectional area of the breather passage is provided by a relatively smooth taper.

14. A pourer as claimed in claim 11, wherein the spout is clamped at a location spaced from the substantial increase in cross sectional area of the breather passage.

15. A pourer as claimed in claim 1, wherein the closure device includes a closure member pivotally movable to clamp the deformable portion.

16. A pourer as claimed in claim 15, wherein the constricting and closure is effected by clamping the deformable portion between the closure member and a backing plate.

17. A pourer as claimed in claim 15, wherein the closure member is a pivotal lever manually operable by pressure at one end to selectively apply and release the clamping pressure.

18. A pourer as claimed in claim 17, wherein the lever is resiliently biased toward a clamping position in which the spout is closed.

19. A pourer as claimed in claim 1, wherein the clamping and constriction of the deformable portion is progressive so that the flow of liquid from the outlet passage can be controlled.

20. A pourer as claimed in claim 1, wherein the spout is clamped closely adjacent to the free end so as to minimize the amount of unclosed spout exposed to the air.

21. A pourer as claimed in claim 1, wherein the spout is formed by a generally tubular wall divided into two passageways by a central wall.

22. A pourer as claimed in claim 21, wherein during clamping of the spout the contacting surfaces of the walls defining the passageways are of the same effective length.

23. A pourer as claimed in claim 1, wherein the spout is clamped between a curved backing plate and the end of a lever.

24. A pourer as claimed in claim 1, wherein a coupling ring is provided to engage a thread or other formation of the container.

25. A pourer as claimed in claim 24, wherein the coupling ring snap engages the container.

26. A pourer as claimed in claim 24, wherein the coupling ring has the same thread as the container, or a thread that is partially compatible with the thread of the container.

27. A pourer as claimed in claim 1, wherein the coupling between the pourer and the container includes a resilient tubular formation which fits into the container opening.

28. A pourer as claimed in claim 1, further including a coupling having circumferentially arranged jaws which clamp against an upper marginal edge portion of the container, and a retaining ring surrounding the jaws to effect the clamping by movement with respect to the jaws.

29. A pourer as claimed in claim 28, wherein the jaws are formed by segments of a cylindrical skirt.

30. A pourer as claimed in claim 28, wherein clamping is effected by engagement of the jaws with a thread or other formation on the container normally used for securing a closure.

31. A container incorporating a pourer as claimed in claim 1.

32. A container as claimed in claim 28, wherein the pourer is substantially integral with the container.

33. A pourer for a container having an opening including a coupling having circumferentially arranged jaws formed by segments of a cylindrical skirt to clamp against a marginal edge portion of the container opening, a retaining ring surrounding the jaws to effect said clamping by movement with respect to the jaws to urge the segments inwardly against the marginal edge portion.

34. A pourer as claimed in claim 33, wherein clamping is effected by engagement of the jaws with a thread or other formation on the container normally used for securing a closure.

35. (canceled)

36. (canceled)
